(19) United States
(12) Patent Application Publication
(10) Pub. No.: US 2007/0262056 A1
(43) Pub. Date: Nov. 15, 2007

(54) Tailor-Welded Blank and Method of Forming Same

(76) Inventors: James Schwaegler, Canton, MI (US); Daniel Fondriest, Howell, MI (US)

Correspondence Address: QUINN LAW GROUP, PLLC, 39555 ORCHARD HILL PLACE, SUITE # 520, NOVI, MI, 48375, US

(21) Appl. No.: 11/383,242

(22) Filed: May 15, 2006

(51) Int. Cl. B23K 11/06

(52) U.S. Cl. 219/83

(57) ABSTRACT

A tailor-welded blank is formed by resistance mash seam welding an overlapped metallic sheet and a laminated steel structure that has a viscoelastic layer sandwiched between steel layers. Preferably, assuming the metallic sheet is approximately 1.3 millimeters (mm) thick and the laminated steel structure is approximately 1.15 millimeters (mm) thick, the weld speed is approximately 7 meters per minute (mpm), the weld pressure is approximately 0.3 millipascals (mPa) and the weld current is approximately 30.3 kiloamps (kA). The tailor-welded blank may be stamped to form an automotive component

### TECHNICAL FIELD

This invention relates to resistance mash seam welding a metallic sheet to a laminated steel structure to form a tailor-welded blank.

### BACKGROUND OF THE INVENTION

Automobiles and other machines are susceptible to noise radiation that, if not addressed, creates an undesirable environment. For example, there are many opportunities for undesirable noise due to vibrating components in a moving automobile. Traditional means for quieting automobiles include mastics, doubler panels, spray-on deadener, and fiberglass matting.

### SUMMARY OF THE INVENTION

Resistance mash seam welding is adapted for forming a tailor-welded blank from a metallic sheet and a laminated steel structure. As used herein, a “tailor-welded blank” is a blank made by welding two dissimilar sheets or sheet-like structures to one another. For instance, tailor-welded blanks of an aluminum sheet welded to a steel sheet are currently used in automobiles in order to benefit from the fuel economy benefits of lower weight aluminum while targeting the higher strength steel to areas where needed. Preferably, the metallic sheet is a monolithic, high strength, low alloy steel. The laminated steel structure has a viscoelastic layer sandwiched between first and second steel layers. This viscoelastic layer may span the entirety of both steel layers. An example of a commercially available laminated steel structure is the product Quiet Steel® from Material Sciences Corporation of Elk Grove Village, Ill., although other laminated steel structures may be utilized within the scope of the invention. A laminated steel structure such as Quiet Steel® is useful in automotive applications to deaden noise. The invention allows such a laminated steel structure to be mechanically connected with a metallic sheet for forming an automotive component having dual capabilities, if, for instance, a certain area of a vehicle requires the high strength characteristics of the metallic sheet while an adjacent area would benefit from the noise reducing capability of the laminated sheet structure.

Specifically, a method of forming a tailor-welded blank includes overlapping the metallic sheet and the laminated steel structure to form a lap. The method further includes resistance mash seam welding the lap to form the tailor-welded blank. The tailor-welded blank may then be stamped to form a component, such as an automotive dashboard. Preferably, the welded lap is in a substantially flat portion of the stamped component to minimize stresses on the welded joint. Optionally, the welded joint may be planished prior to stamping.

In one embodiment, where the metallic sheet is approximately 1.3 millimeters (mm) thick and the laminated steel structure is approximately 1.15 millimeters (mm) thick, the lap is preferably about 8 millimeters (mm) in width and the resistance mash seam welding is performed with a pressure of approximately 0.3 millipascals (mPa), an electric current of approximately 30.3 kiloamps (kA) and at a weld speed of approximately 7 meters per minute (mpm). These parameters produce an acceptable welded joint strength with a hardness value greater than either of the parent materials (i.e., the metallic sheet and the laminated steel structure).

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective illustration of a vehicle dashboard stamped from a tailor-welded blank within the scope of the invention;

FIG. 2 is a schematic partially cross-sectional illustration of overlapped sheet steel and laminated steel structure used in the tailor-welded blank of FIG. 1 just prior to resistance mash seam welding; and

FIG. 3 is a schematic cross-sectional illustration of the resistance mash seam welded tailor-welded blank of FIG. 1 prior to stamping, illustrating the effect of optional planishing.

### DESCRIPTION OF THE PREFERRED EMBODIMENTS

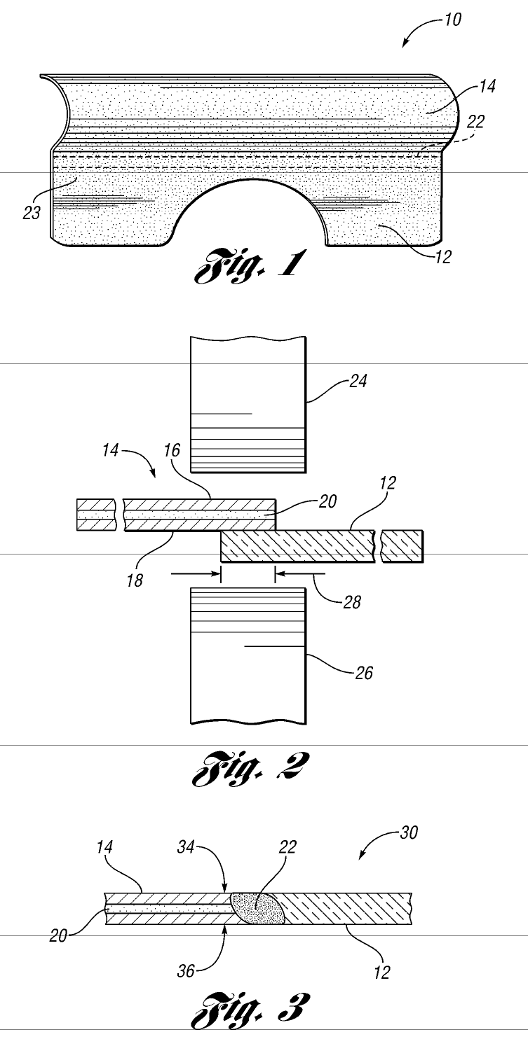

Referring to the drawings, wherein like reference numbers refer to like components, an automobile dashboard 10 stamped from a tailor-welded blank is illustrated. The dashboard 10 is formed with a metallic sheet 12 welded to a laminated steel structure 14. The laminated steel structure 14 is positioned at an upper part of the dashboard in order to insulate the passenger compartment from noise. The laminated steel structure 14 may be Quiet Steel® or any other vibration damped laminated steel. As illustrated in FIG. 2, the laminated steel structure 14 includes a first steel sheet 16, a second steel sheet 18 and a viscoelastic layer 20 preferably spanning the entirety of the surfaces between the first and second steel sheets 16, 18. The metallic sheet 12 is preferably a monolithic high strength low alloy steel such as SAE 1020 or less. As used herein, a “monolithic” steel sheet means a steel sheet having a uniform crystalline structure throughout. Referring again to FIG. 1, a welded joint 22 shown in phantom is formed by resistance mash roller seam welding the metallic sheet 12 and the laminated steel structure 14 to one another as described herein. The welded joint 22 is positioned in a relatively flat portion 23 of the dashboard 10 so that the welded joint 22 is not subjected to undue stress during stamping.

Referring to FIG. 2, prior to resistance mash seam welding using upper and lower seam weld wheel electrodes 24, 26, the laminated steel structure 14 is overlapped with the metallic sheet 12 to form a lap 28 (i.e., the overlapped portion of the laminated steel structure 14 and the metallic sheet 12). The wheel electrodes 24, 26 are shown in fragmentary view with the respective axes of rotation not shown but parallel to the laminated steel structure 14 and the steel sheet 12. For a laminated steel structure 14 approximately 1.15 millimeters (mm) thick and a metallic sheet 12 of high strength low alloy steel (SAE 1020 or less) approximately 1.3 millimeters (mm) thick, the lap 28 is preferably 8 millimeters (mm) in width. The wheel electrodes 24, 26 are moved toward the laminated steel structure 14 and the metallic sheet 12 and a pressure of 0.3 millipascals (mPa) is applied to the laminated steel structure 14 and metallic sheet 12 at the lap 28 via the wheel electrodes 24, 26. The laminated steel structure 14 and metallic sheet 12 are supported along their lengths on either side of the wheels electrodes 24, 26 such that they can be moved in a direction perpendicular to the cross-section shown at approximately 7 meters per minute (mpm) to rotate the wheel electrodes 24, 26. As the wheel electrodes 24, 26 rotate, electric current of 30.3 kiloamps (kA) is applied across the seam weld wheel electrodes 24, 26 with continuous current pulsing. When the entire length of the lap 28 has moved between the wheel electrodes 24, 26, the wheels electrodes 24, 26 are backed away and a tailor-welded blank 30 is thereby formed with a welded joint 22 connecting the metallic sheet 12 with the laminated steel structure 14. The pressure and heat from the rotating electrodes 24, 26 cause the laminated steel structure 14 and the metallic sheet 12 to fuse, forming the welded joint 22 generally in what was previously the region of the lap 28. Optionally, the area around the welded joint 22 is planished so that the upper surface 34 and the lower surface 36 of the tailor welded blank 30 are substantially planar. The planishing process involves compressing the welded joint between steel rollers, as is understood by those skilled in the art. The tailor-welded blank 30 is then ready to be stamped in a die to form the dashboard 10 of FIG. 1. Different material thicknesses of the laminated steel structure 14 and the metallic sheet 12 may require modification of the lap width, weld pressure, weld speed and weld current.

A method of tailor-welding a blank, described with respect to the structure of FIGS. 1 to 3, includes overlapping the metallic sheet 12 with the laminated steel structure 14 and resistance mash seam welding the two together to form a tailor welded blank 30. The preferred weld characteristics are obtained with a weld pressure of 0.3 millipascals (mPa), a current of 30.3 kiloamps (kA) and a weld speed of 7 meters per minute (mpm), where weld pressure is the force that the electrode wheels 24, 26 apply to the laminated structure 14 and the metallic sheet 12 divided by the area of contact of the wheel electrodes 24, 26, the current is applied through the wheel electrodes 24, 26, and the weld speed is the speed at which the laminated structure 14 and the metallic sheet 12 pass between the electrode wheels 24, 26. Optionally, the method includes planishing the tailor-welded blank 30, especially in the area of the welded joint 22. Finally, the method includes stamping the tailor-welded blank 30 to form a component such as the automobile dashboard 10.

Vickers hardness measurements across the welded joint 22 were performed on various tailor welded blanks of Quiet Steel® resistance mash welded to a metallic sheet of high strength low alloy steel. A microhardness measurement of a tailor-welded blank of high strength low alloy steel (SAE 1020) resistance mash welded to Quiet Steel® at a weld current of 30.3 kiloamps (kA), with a pressure of 0.30 millipascals (mPa) and at a weld speed of 7 meters per minute (mpm) yielded a Vickers hardness of approximately 200, which is in an acceptable range for a vehicle dashboard. The Vickers microhardness of the Quiet Steel® is generally 100. The high strength low alloy steel base metal used has a Vickers hardness of about 150. Thus, the Vickers hardness of the tailor-welded joint 22 using the above weld parameters exceeds that of either of these “parent” materials. Tailor-welded blanks of 1.15 millimeter (mm) thick Quiet Steel® resistance mash seam welded to 1.3 millimeter (mm) thick high strength low alloy steel (SAE 1020) tested with the following weld parameters exhibited acceptable hardness and tensile tests results: weld current of 30.3 kiloamps (kA), weld pressure of 0.23 millipascals (mPa) (2068 pounds (lbs.)) and weld speed of 7 meters per minute (mpm); weld current of 30.3 kiloamps (kA), weld pressure of 0.23 millipascals (mPa) and weld speed of 6.5 meters per minute (mpm). With a weld current of 28.3 kiloamps (kA), weld pressure of 0.23 millipascals (mPa) and weld speed of 6.5 meters per minute (mpm), weld failure was exhibited during a tensile test. With a weld current of 30.3 kiloamps (kA), weld pressure of 0.4 millipascals (mPa) (3597 lbs.) and weld speed of 7 meters per minute (mpm), weld failure occurred during tensile testing and a weld line was visible, indicating a lack of fusion. Based on this testing, the optimal parameters were determined to be weld current of 30.3 kiloamps (kA), weld pressure of 0.3 millipascals (mPa) and weld speed of 7 meters per minute (mpm).

While the best modes for carrying out the invention have been described in detail, those familiar with the art to which this invention relates will recognize various alternative designs and embodiments for practicing the invention within the scope of the appended claims.

1. A method of forming a blank comprising:
overlapping a metallic sheet and a laminated steel structure to form a lap;
wherein the laminated steel structure has a first steel layer and a second steel layer with a viscoelastic layer therebetween; and
resistance mash seam welding the lap into a welded joint to thereby form a tailor-welded blank.

2. The method of claim 1, wherein said viscoelastic layer spans the entirety of both steel layers.

3. The method of claim 1, wherein said metallic sheet is monolithic high strength low alloy steel.

4. The method of claim 1, wherein said laminated steel structure is approximately 1.15 millimeters (mm) thick and said metallic sheet is approximately 1.3 millimeters (mm) thick; and wherein said lap is approximately 8 millimeters (mm).

5. The method of claim 1, wherein said laminated steel structure is approximately 1.15 millimeters (mm) thick and said metallic sheet is approximately 1.3 millimeters (mm) thick; and wherein said resistance mash seam welding is at a weld speed between 6.5 and 7.5 meters per minute (mpm).

6. The method of claim 1, wherein said laminated steel structure is approximately 1.15 millimeters (mm) thick and said metallic sheet is approximately 1.3 millimeters (mm) thick; and wherein said resistance mash seam welding is characterized by a weld pressure between 0.20 and 0.35 millipascals (mPa).

7. The method of claim 1, wherein said laminated steel structure is approximately 1.15 millimeters (mm) thick and said metallic sheet is approximately 1.3 millimeters (mm) thick; and wherein said resistance mash seam welding is characterized by an electric current not less than 29.5 and not greater than 30.5 kiloamps (kA).

8. The method of claim 1, further comprising:
after said resistance mash seam welding, planishing the welded joint.

9. The method of claim 1, further comprising:
after said resistance mash seam welding, stamping the tailor-welded blank to thereby form an automotive component.

10. The method of claim 9, wherein said automotive component is a vehicle dashboard.

11. The method of claim 9, wherein substantially all of said welded joint is at a substantially flat portion of said automotive component

12. A method of forming a blank comprising:
overlapping a monolithic high strength steel sheet and a laminated steel structure to form a lap; wherein the laminated steel structure has a first steel layer and a second steel layer with a viscoelastic layer therebetween; wherein said laminated steel structure is approximately 1.15 millimeters (mm) thick and said metallic sheet is approximately 1.3 millimeters (mm) thick;
resistance mash seam welding the lap to thereby form a tailor-welded blank; wherein said lap is approximately 8 millimeters (mm); wherein said resistance mash seam welding is at a weld speed of approximately 7 meters per minute (mpm);
wherein said resistance mash seam welding is characterized by a pressure of approximately 0.3 millipascals (mPa); wherein said resistance mash seam welding is characterized by an electric current of approximately 30.3 kiloamps (kA); and
after said resistance mash seam welding, stamping the tailor-welded blank to thereby form an automotive component.

13. A tailor-welded blank comprising:
a monolithic metallic sheet;
a laminated steel structure having a first steel layer, a second steel layer and a viscoelastic layer therebetween; and
wherein a resistance mash seam welded joint extends between said monolithic metallic sheet and said laminated steel structure.

14. The tailor-welded blank of claim 13, wherein said monolithic metallic sheet is high strength low alloy steel.
